(19) United States
(12) Patent Application Publication
(10) Pub. No.: US 2016/0276107 A1
(43) Pub. Date: Sep. 22, 2016

(54) Trimmer Capacitor

(71) Applicant: Johanson Manufacturing Corporation, Boonton, NJ (US)

(72) Inventors: Mark Imbimbo, Butler, NJ (US); Ronald Vecchio, Morris Plains, NJ (US)

(73) Assignee: JOHANSON MANUFACTURING CORPORATION, Boonton, NJ (US)

(21) Appl. No.: 14/660,354

(22) Filed: Mar. 17, 2015

(51) Int. Cl. H01G 5/16

(52) U.S. Cl. CPC H01G 5/16

(57) ABSTRACT

A trimmer capacitor is provided which includes a conductive bushing having a first terminal of the capacitor formed integrally therewith, a rotor that is threadably engageable with the bushing, and a dielectric portion attached at one end to the bushing and having a stator surrounding the dielectric portion near the opposite end thereof. The stator forms the second terminal of the capacitor. The rotor includes transverse slots which bias the rotor in position against the bushing, to prevent undesired rotation of the rotor.

### BACKGROUND OF THE INVENTION

1. Field of the Invention

The present disclosure relates to a trimmer capacitor.

2. Related Art

Capacitors are passive electrical devices which store electrical charge. Most capacitors consist of two conductors insulated from each other by a dielectric, whereby electrical charge is stored on the conductors. Often, capacitors are used in filtration applications, such as in power supplies and in radio frequency (RF) circuits.

A common type of capacitor is the “trimmer” capacitor, the capacitance of which can be varied by adjusting a portion of the capacitor (e.g., by turning a screw). Often, trimmer capacitors are used to make precise adjustments to the capacitance of a circuit, such as in microwave transceiver applications. In such applications, the trimmer capacitor can be used to adjust the resonance of an RF circuit (i.e., to “tune” the circuit) to a desired frequency.

It is known to provide a trimmer capacitor having a conductive bushing, a first terminal attached to the bushing, a rotor threadably engaged to the bushing, a cylindrical dielectric portion attached at one end to the conductive bushing, and a stator attached at an opposite end of the dielectric portion, wherein the stator serves as the second terminal of the capacitor. The capacitance of such a device can be adjusted by selectively turning the rotor, which causes the rotor to advance toward or away from the stator. By varying the distance between the rotor and the stator, the capacitance of the device is adjusted.

### SUMMARY OF THE INVENTION

The present disclosure relates to a trimmer capacitor. The capacitor generally includes a conductive bushing having a first terminal of the capacitor formed integrally therewith, a rotor threadably engageable with the bushing, and a dielectric portion attached at one end to the bushing and having a stator surrounding the dielectric portion near an opposite end of the dielectric portion. The stator can be press-fit onto the dielectric portion, or formed on the dielectric portion by metallization. The stator forms the second terminal of the capacitor, and can be positioned above the bottom edge of the dielectric portion. Capacitance can be adjusted by selectively rotating the rotor, which causes the rotor to move toward or away from the stator. The rotor includes transverse slots which bias the rotor in position against the bushing, to prevent undesired rotation of the rotor. The trimmer capacitor disclosed herein provides manufacturing and cost advantages because it is formed from fewer components than existing trimmer capacitors.

The present disclosure also relates to a method for manufacturing a trimmer capacitor. The method includes the steps of forming a bushing having an integral terminal and a threaded inner surface, forming a cylindrical dielectric portion, forming a rotor, disposing a stator on an outer surface of the cylindrical dielectric portion, attaching one end of the dielectric portion to one end of the bushing, and threading the rotor into the bushing.

### BRIEF DESCRIPTION OF THE DRAWINGS

The foregoing features of the disclosure will be apparent from the following Detailed Description of the Invention, taken in connection with the accompanying drawings, in which:

FIG. 1 is a side view showing the trimmer capacitor of the present disclosure;

FIG. 2 is a top view of the trimmer capacitor of FIG. 1;

FIGS. 3A-3B are partial cross-sectional views (taken along line 3-3 of FIG. 2) showing operation of the trimmer capacitor of FIG. 1;

FIG. 4 is a side view of the trimmer capacitor shown in a mounted configuration; and

FIG. 5 is a partial cross-sectional view showing another embodiment of the trimmer capacitor.

### DETAILED DESCRIPTION OF THE INVENTION

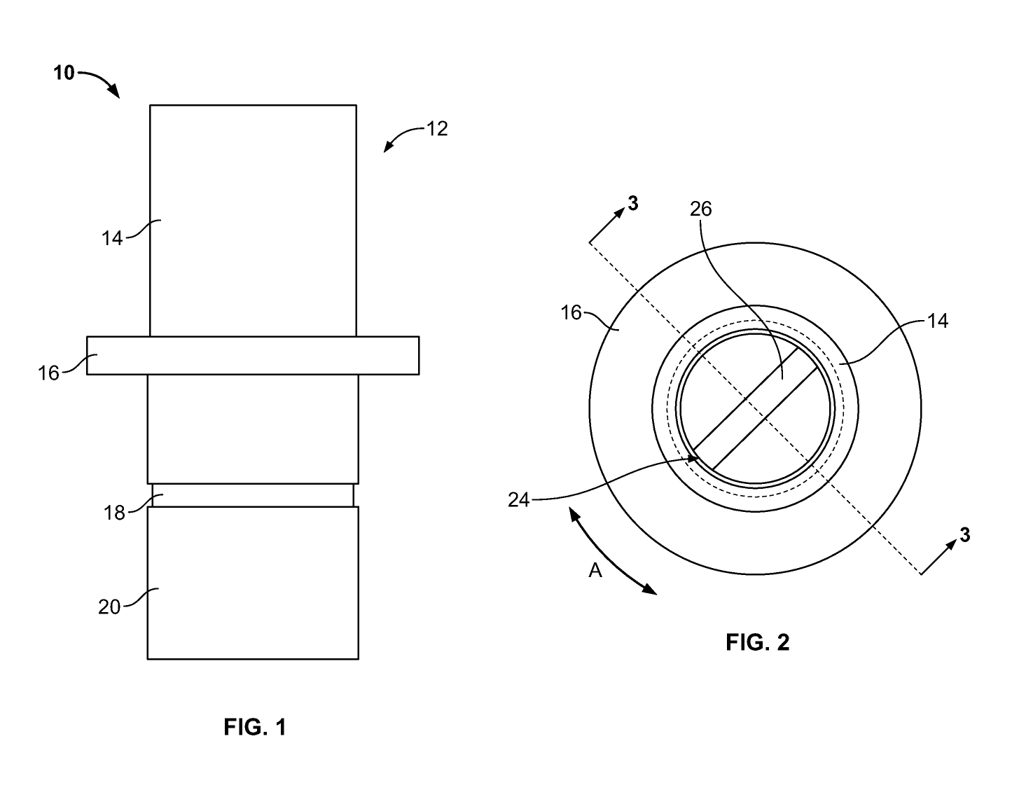

The present disclosure relates to a trimmer capacitor, as discussed in detail below in connection with FIGS. 1-5.

FIG. 1 is a side view showing the trimmer capacitor of the present disclosure, indicated generally at 10. The trimmer capacitor 10 includes a conductive bushing 12 having a cylindrical body 14 and a flanged terminal 16 formed integrally with and extending radially from the body 14, a cylindrical dielectric portion 18, and a stator 20 press-fit on an outer surface of the dielectric portion 18. The stator 20 provides a second terminal for the capacitor 10. As can be seen in the Figures, the stator 20 could comprise a cylindrical band about the dielectric portion 18. The stator 20 can be directly soldered to a printed circuit board. The stator 20 could be press-fit on a portion of the outer surface of the dielectric portion 18 using a suitable press-fitting process. Additionally, the stator 20 could be formed directly on the outer surface of the dielectric portion 18 using a suitable metallization process.

Advantageously, by forming the flanged terminal 16 integrally with the bushing 12, manufacturing steps and costs are reduced. Of course, it is noted that the flanged terminal 16 need not be formed integrally with the bushing 12, and could be formed separately from the bushing 12 and subsequently attached thereto (e.g., by forming the flanged terminal 16 as a collar and press-fitting the collar over a bulge on the bushing 12). As will be discussed below, the bushing 12 includes internal threads for threadably receiving a rotor which can be selectively rotated with respect to the bushing 12 to adjust the capacitance of the capacitor 12.

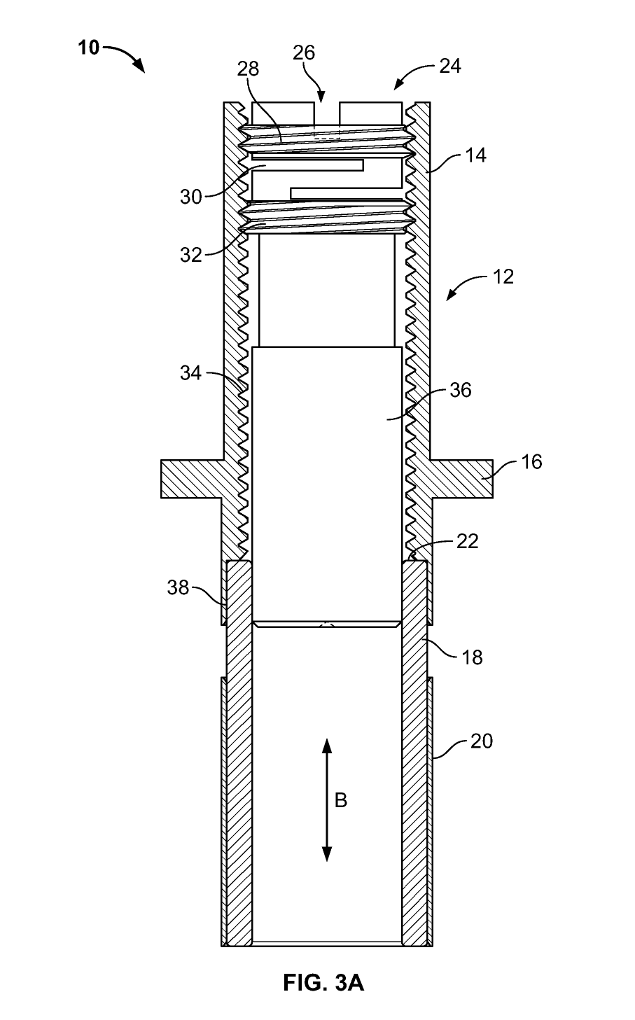

FIG. 2 is a top view of the trimmer capacitor 10 shown in FIG. 1. A rotor 24 is received by, and is threadably engageable with, the body 14 of the bushing 12, and can be selectively rotated with respect to the body 14 (as indicated by arrow A) to adjust the capacitance of the capacitor 10. A slot 26 could be provided for accepting a screwdriver or other tool, which could be used to rotate the rotor 24. Of course, any other type of engagement between the rotor 24 and an operating tool (e.g., Phillips-style slot, hexagonal recess, etc.) could be provided without departing from the spirit or scope of the present disclosure.

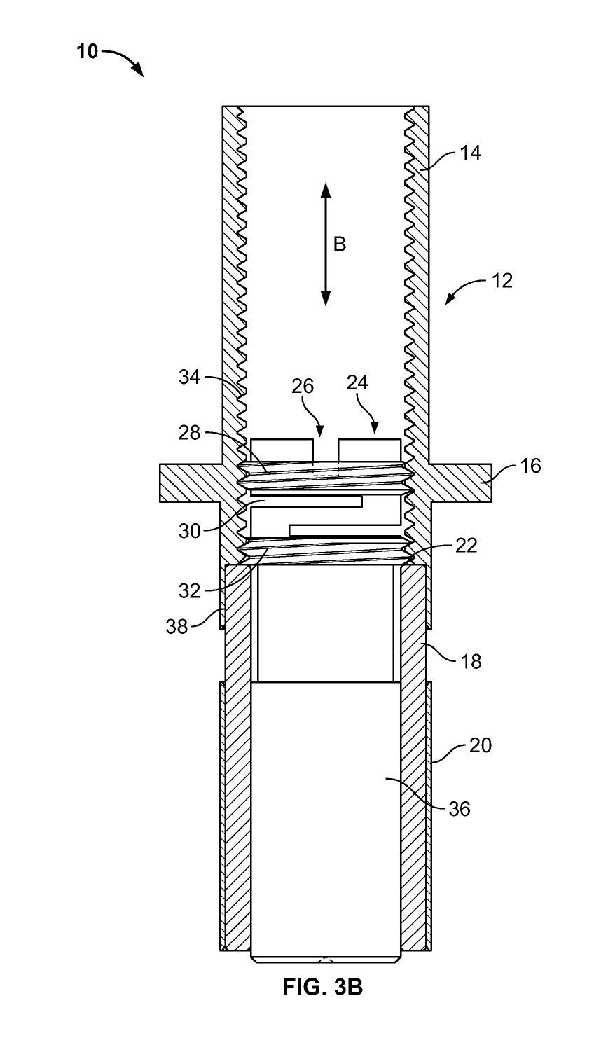

FIGS. 3A-3B are cross-sectional views showing operation of the trimmer capacitor of the present disclosure. As seen in FIG. 3A (taken along the line 3-3 of FIG. 2), the body 14 of the bushing 12 includes a threaded inner surface 34 which receives upper and lower threaded portions 28 and 32 of the rotor 24. The upper and lower threaded portions 28 and 32 are separated by an unthreaded portion. One or more transverse slots 30 could be provided in the unthreaded portion of the rotor 24, such that the upper threaded portion 28 is slightly offset with respect to the lower threaded portion 32. Such an arrangement causes the threaded portions 28, 32 to be biased against the threaded inner surface 34, so that unwanted rotation of the rotor 24 is reduced. The body 14 of the bushing 12 includes an annular recess 38 for receiving an upper end of the dielectric portion 18. The dielectric portion 18 could be held in place in the annular recess 38 by way of a friction fit between the dielectric portion 18 and the annular recess 38. It could also be held in place by an adhesive (e.g., epoxy).

The rotor 24 also includes a cylindrical portion 36 which extends from the lower threaded portion 32 and is received by the dielectric portion 18. The cylindrical portion 36 could be solid or hollow, and is in electrical communication with the bushing 12 by way of the threaded upper and lower portions 28, 32. When the rotor 24 is rotated, the cylindrical portion 36 is selectively advanced toward or away from the stator 20, as indicated by arrow B. This causes the capacitance of the device to be adjusted as desired. FIG. 3A depicts capacitor 10 adjusted to minimum capacitance, wherein the rotor 24 is minimally engaged with the threaded inner surface 34 of bushing 12. Conversely, FIG. 3B depicts capacitor 10 adjusted to maximum capacitance, wherein the rotor 24 is fully engaged with the threaded inner surface 34 of bushing 12. As shown in FIG. 3B, the rotor 24 can be advanced (rotated) to a final position, such that the threaded lower portion 32 rests against a shoulder 22 of the dielectric portion 18, thereby preventing further travel of the rotor 24.

The bushing 12 and rotor 24 could be formed from any suitable conductive metal, such as brass, and could be non-magnetic. The dielectric portion 18 could be formed from any suitable dielectric material, including, but not limited to, alumina (Al₂O₃), zirconia, or sapphire. The stator 20 could be formed from brass, silver, moly-manganese, copper, tin plate, or any other suitable material and thereafter being plated with silver. As mentioned above, the stator 20 could be press-fit directly on the outer surface of the dielectric portion 18 using a suitable press-fitting process. In an alternative embodiment, the stator 20 could be formed directly on the outer surface of the dielectric portion 18 using a suitable metallization process and thereafter being plated with silver.

The trimmer capacitor 10 could be formed using the following manufacturing steps. First, the bushing 12 (including the cylindrical body 14 and integral flanged terminal 16) could be formed using a precision milling process. Then, the rotor 24 could be formed using precision milling processes. Once the dielectric portion 18 is formed by pressing and sintering, the stator 20 could be press-fit on a portion of the outer surface of the dielectric portion 18 using a press-fitting process. Alternatively, the stator 20 could be formed directly on a portion of the outer surface of the dielectric portion 18 using a metallization process. Once the stator 20 is in place, one end of the dielectric portion 18 is fit into the annular recess 38 of the bushing 12. The dielectric portion 18 could be attached to the bushing 12 by way of a frictional fit, or by an adhesive (e.g., epoxy) applied to the annular recess 38 before insertion of the dielectric portion 18. When the dielectric portion 18 is attached to the bushing 12, the rotor 24 is threaded into the bushing 12, forming a complete trimmer capacitor in accordance with the present disclosure.

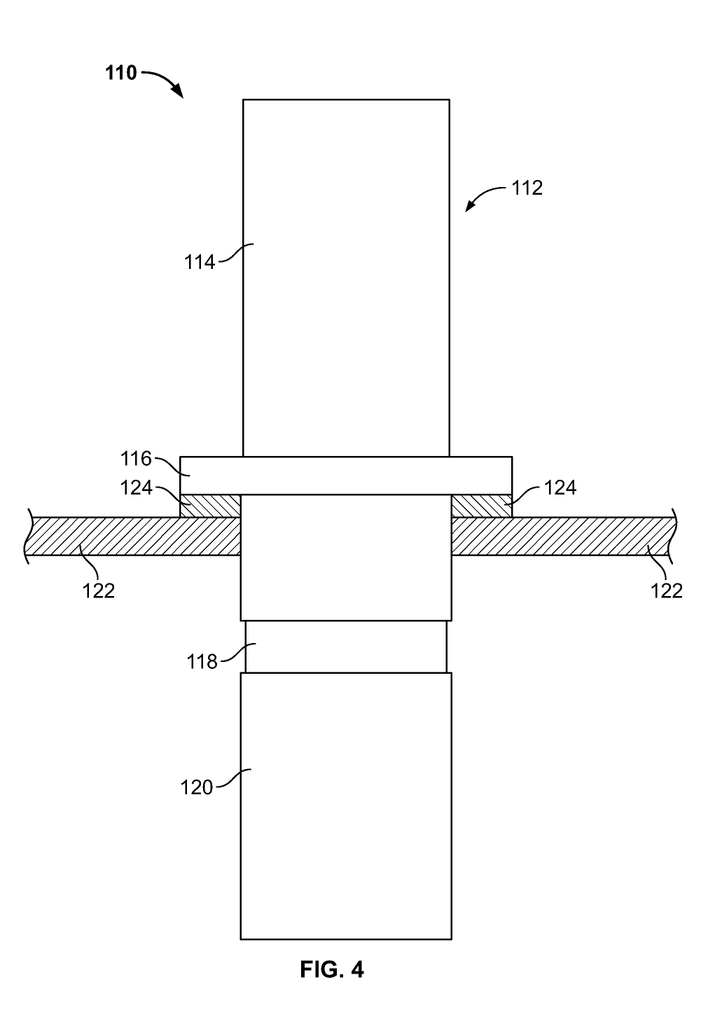

FIG. 4 is a partial cross-sectional view showing the trimmer capacitor in a mounted configuration. As seen in FIG. 4 trimmer capacitor 110 is longer than the capacitor 10 of FIG. 1, and can be flange mounted on a printed circuit board 122. The body 114 of bushing 112 is disposed through a suitably sized aperture in printed circuit board 122. The flanged terminal 116 of bushing 112 is electrically coupled to printed circuit board 122 by solder pad 124 disposed between flanged terminal 116 and printed circuit board 122. Flange mounting of the present disclosure provides installation advantages, such that the bushing 112 can be disposed through an aperture in the printed circuit board 122 and directly soldered to the printed circuit board 122 without the need for additional support of the capacitor 110 throughout the soldering operation. As can be appreciated, the capacitor of the present disclosure can be provided in various lengths if desired.

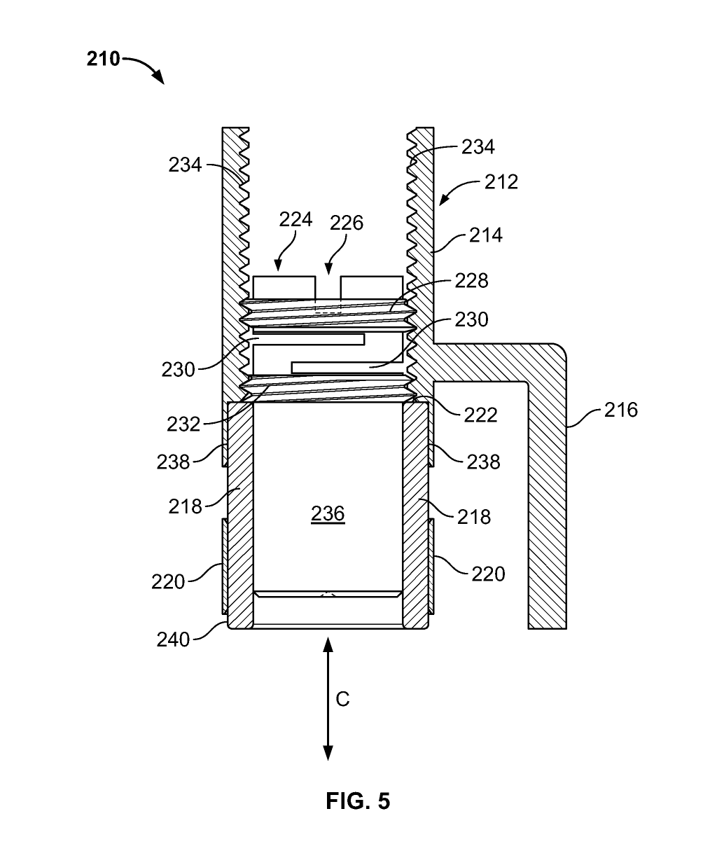

FIG. 5 is a partial cross-sectional view showing another embodiment of the trimmer capacitor of the present disclosure. The trimmer capacitor 210 includes a conductive bushing 212 having a cylindrical body 214 and a vertical terminal 216 formed integrally with and extending from the body 214, a cylindrical dielectric portion 218, and a stator 220 press-fit on an outer surface of the dielectric portion 218. The stator 220 provides a second terminal for the capacitor 210, and can positioned so that a lower portion 240 of the dielectric portion 218 is exposed, i.e., the stator 220 is positioned above the bottom edge of the dielectric portion 218. As can be seen in the Figures, the stator 220 could comprise a cylindrical band about the dielectric portion 218. This provides installation advantages, such that the stator 220 could be directly soldered to a printed circuit board. The stator 220 could be press-fit on a portion of the outer surface of the dielectric portion 218 using a suitable press-fitting process, or formed directly on the outer surface of the dielectric portion 218 using a suitable metallization process.

Advantageously, by forming the vertical terminal 216 integrally with the bushing 212, manufacturing steps and costs are reduced. Of course, it is noted that the vertical terminal 216 need not be formed integrally with the bushing 212, and could be formed separately from the bushing 212 and subsequently attached thereto (e.g., by way of a collar extending from the vertical terminal 216 and press-fit over a bulge on the bushing 212). As will be discussed below, the bushing 212 includes internal threads for threadably receiving a rotor which can be selectively rotated with respect to the bushing 212 to adjust the capacitance of the capacitor 212.

As seen in FIG. 5, the body 214 of the bushing 212 includes a threaded inner surface 234 which receives upper and lower threaded portions 228 and 232 of a rotor 224. The upper and lower threaded portions 228 and 232 are separated by an unthreaded portion. One or more transverse slots 230 could be provided in the unthreaded portion of the rotor 224, such that the upper threaded portion 228 is slightly offset with respect to the lower threaded portion 232. Such an arrangement causes the threaded portions 228, 232 to be biased against the threaded inner surface 234, so that unwanted rotation of the rotor 224 is reduced. The body 214 of the bushing 212 includes an annular recess 238 for receiving an upper end of the dielectric portion 218. The dielectric portion 218 could be held in place in the annular recess 238 by way of a friction fit between the dielectric portion 218 and the annular recess 238. It could also be held in place by an adhesive (e.g., epoxy).

The rotor 224 also includes a cylindrical portion 236 which extends from the lower threaded portion 232 and is received by the dielectric portion 218. The cylindrical portion 236 could be solid or hollow, and is in electrical communication with the bushing 212 by way of the threaded upper and lower portions 228, 232. When the rotor 224 is rotated, the cylindrical portion 236 is selectively advanced toward or away from the stator 220, as indicated by arrow C. This causes the capacitance of the device to be adjusted as desired. FIG. 5 depicts capacitor 210 adjusted to maximum capacitance, wherein the rotor 224 is fully engaged with the threaded inner surface 234 of bushing 212. As shown in FIG. 5, the rotor 224 can be advanced (rotated) to a final position, such that the threaded lower portion 232 rests against a shoulder 222 of the dielectric portion 218 and the cylindrical portion 236 is positioned entirely within the dielectric portion 218. The shoulder 222 prevents the rotor 224 from traveling past the threads 234 of the bushing 212, and can also prevent the cylindrical portion 236 from contacting a printed circuit board (and “shorting out” the capacitor 210).

The bushing 212 and rotor 224 could be formed from any suitable conductive metal, such as brass, and could be non-magnetic. The dielectric portion 218 could be formed from any suitable dielectric material, including, but not limited to, alumina (Al₂O₃), zirconia, or sapphire. The stator 220 could be formed from brass, silver, moly-manganese, copper, tin plate, or any other suitable material and thereafter being plated with silver. As mentioned above, the stator 220 could be press-fit directly on the outer surface of the dielectric portion 218 using a suitable press-fitting process, or it could be formed directly on the outer surface of the dielectric portion 218 using a suitable metallization process and thereafter being plated with silver.

The trimmer capacitor 210 could be formed using the following manufacturing steps. First, the bushing 212 (including the cylindrical body 214 and integral vertical terminal 216) could be formed using a precision milling process. Then, the rotor 224 could be formed using a precision milling processes. Once the dielectric portion 218 is formed by pressing and sintering, the stator 220 could be press-fit on a portion of the outer surface of the dielectric portion 218 using a press-fitting process. Alternatively, the stator 220 could be formed directly on a portion of the outer surface of the dielectric portion 218 using a metallization process. Once the stator 220 is in place, it is thereafter silver plated. Next, one end of the dielectric portion 218 is fit into the annular recess 238 of the bushing 212. The dielectric portion 218 could be attached to the bushing 212 by way of a frictional fit, or by an adhesive (e.g., epoxy) applied to the annular recess 238 before insertion of the dielectric portion 218. When the dielectric portion 218 is attached to the bushing 212, the rotor 224 is threaded into the bushing 212, forming a complete trimmer capacitor in accordance with the present disclosure.

The trimmer capacitor of the present disclosure could have a wide range of operating frequencies. For example, an operating frequency range of 800 MHz to 2.1 GHz is possible, which is advantageous for usage of the trimmer capacitor in various RF applications including WiMax, cellular telephony, and global positioning system (GPS) applications. A capacity range of 0.6 to 3.0 picofarads (pF) could be provided, which corresponds roughly to 8 full rotations of the rotor of the rotor of the trimmer capacitor. A working voltage of 250 volts direct current (DC) could be provided, with a test voltage of 500 volts DC. The capacitor could have a quality (“Q”) rating of greater than 2,000, and an insulation resistance of greater than 10⁶ megohms. An operating temperature range of −65 degrees Celsius to +125 degrees Celsius is possible, and the rotor of the trimmer capacitor can be operated with torque in the range of 0.2 to 2.0 oz.-inch. Moisture resistance ratings of 10-24 hour cycles is also possible. These operational parameters could be varied without departing from the spirit or scope of the present disclosure.

Having thus described the disclosure in detail, it is to be understood that the foregoing description is not intended to limit the spirit or scope thereof. What is desired to be protected is set forth in the following claims.

What is claimed is:

1. A trimmer capacitor, comprising:
a bushing having a threaded inner surface and a first terminal;
a dielectric portion attached at one end to the bushing;
a press-fit stator disposed on an outer surface of the dielectric portion, the press-fit stator forming a second terminal of the capacitor; and
a rotor threadably engageable with the threaded inner surface of the bushing, the rotor including at least one transverse slot for biasing the rotor against the threaded inner surface of the bushing,
wherein the rotor is selectively rotatable to move the rotor with respect to the stator to adjust a capacitance of the capacitor.

2. The capacitor of claim 1, wherein the first terminal is flanged.

3. The capacitor of claim 1, wherein the first terminal is vertical.

4. The capacitor of claim 1, wherein the first terminal is formed integrally with the bushing.

5. The capacitor of claim 1, wherein the press-fit stator is silver plated.

6. The capacitor of claim 1, wherein the rotor includes upper and lower sets of threads separated by an unthreaded portion.

7. The capacitor of claim 6, wherein the at least one transverse slot is positioned in the unthreaded portion.

8. The capacitor of claim 6, wherein the upper set of threads is offset with respect to the lower set of threads to bias the rotor against the threaded inner surface of the bushing.

9. The capacitor of claim 6, wherein the rotor includes a cylindrical portion extending from the lower set of threads and positioned at least partially within the dielectric portion.

10. The capacitor of claim 9, wherein the cylindrical portion is selectively advanceable toward or away from the stator by rotating the rotor to adjust the capacitance of the capacitor.

11. The capacitor of claim 1, further comprising an exposed portion about a lower perimeter of the dielectric portion which separates the metallized stator from a lower edge of the dielectric portion.

12. The capacitor of claim 1, wherein the bushing includes an annular recess for receiving an end of the dielectric portion.

13. The capacitor of claim 1, wherein an upper edge of the dielectric portion includes a shoulder for limiting rotation of the rotor.

14. A trimmer capacitor, comprising:
a bushing having a threaded inner surface and a flanged first terminal;
a dielectric portion attached at one end to the bushing;
a metallized stator formed on an outer surface of the dielectric portion, the metallized stator forming a second terminal of the capacitor; and
a rotor threadably engageable with the threaded inner surface of the bushing, the rotor including at least one transverse slot for biasing the rotor against the threaded inner surface of the bushing,
wherein the rotor is selectively rotatable to move the rotor with respect to the stator to adjust a capacitance of the capacitor.

15. The capacitor of claim 14, wherein the flanged first terminal is formed integrally with the bushing.

16. The capacitor of claim 14, wherein the metallized stator is silver plated.

17. The capacitor of claim 14, wherein the rotor includes upper and lower sets of threads separated by an unthreaded portion.

18. The capacitor of claim 17, wherein the at least one transverse slot is positioned in the unthreaded portion.

19. The capacitor of claim 17, wherein the upper set of threads is offset with respect to the lower set of threads to bias the rotor against the threaded inner surface of the bushing.

20. The capacitor of claim 17, wherein the rotor includes a cylindrical portion extending from the lower set of threads and positioned at least partially within the dielectric portion.

21. The capacitor of claim 20, wherein the cylindrical portion is selectively advanceable toward or away from the stator by rotating the rotor to adjust the capacitance of the capacitor.

22. The capacitor of claim 14, further comprising an exposed portion about a lower perimeter of the dielectric portion which separates the metallized stator from a lower edge of the dielectric portion.

23. The capacitor of claim 14, wherein the bushing includes an annular recess for receiving an end of the dielectric portion.

24. The capacitor of claim 14, wherein an upper edge of the dielectric portion includes a shoulder for limiting rotation of the rotor.

25. A method for manufacturing a trimmer capacitor, comprising the steps of:
forming a bushing having a threaded inner surface and a first terminal, a dielectric portion, and a rotor;
press-fitting a stator on a portion of an outer surface of the dielectric portion, the stator functioning as a second terminal of the capacitor;
attaching an end of the dielectric portion to the bushing; and
threading the rotor into the bushing.

26. The method of claim 25, wherein the step of forming the bushing comprises forming the first terminal integrally with the bushing.

27. The method of claim 25, wherein the step of forming the bushing comprises forming an annular recess within one end of the bushing.

28. The method of claim 25, further comprising the step of silver plating the stator.

29. The method of claim 27, wherein the step of attaching the end of the dielectric portion to the bushing comprises inserting the end of the dielectric portion into annular recess.

30. The method of claim 27, wherein the step of attaching the end of the dielectric portion to the bushing comprises frictionally retaining the end of the dielectric portion in the annular recess.

31. The method of claim 27, wherein the step of attaching the end of the dielectric portion to the bushing comprises applying an adhesive to the annular recess prior to inserting the end of the dielectric portion into the annular recess.

32. The method of claim 27, wherein the step of forming the rotor comprises the step of forming a rotor including a cylindrical body, upper and lower sets of threads, and at least one slot separating the upper and lower sets of threads.
